(19) United States
(12) Patent Application Publication
(10) Pub. No.: US 2022/0156685 A1
(43) Pub. Date: May 19, 2022

(54) METHODS AND APPARATUS FOR REDUCING FOOD WASTE

(71) Applicant: Liam A. Dugan, Sleepy Hollow, NY (US)

(72) Inventor: Liam A. Dugan, Sleepy Hollow, NY (US)

(21) Appl. No.: 17/528,179

(22) Filed: Nov. 16, 2021

Related U.S. Application Data
(60) Provisional application No. 63/114,503, filed on Nov. 16, 2020.

(51) Int. Cl. G06Q 10/08

(52) U.S. Cl. CPC G06Q 10/087

(57) ABSTRACT

A system for reducing food waste of a user is provided that includes a store computer configured to forward food expiration information for a food item to a user device. The system also includes an application executable on a user device, the application having computer program code that, when executed by the user device, causes the user device to (a) receive food expiration information from the store computer regarding a food item purchased by the user; and (b) generate an alert on the user device, the alert indicating to the user that the food item will expire within a predetermined time period. Numerous other aspects are provided.

### CROSS REFERENCE TO RELATED APPLICATION

The present application claims priority to and the benefit of U.S. Provisional Patent Application No. 63/114,503, filed Nov. 16, 2020 and titled “Methods and Apparatus For Reducing Food Waste,” which is hereby incorporated by reference herein in its entirety for all purposes.

### FIELD

The present application relates to food waste, and more particularly to reducing food waste.

### BACKGROUND

The United States wastes over a hundred billion pounds and a hundred billion dollars of food each year (www.usda.gov/foodwaste/faqs). Reducing food waste would allow such resources to be used to feed those in need while reducing unnecessary greenhouse gas emissions and reducing pesticide use. As such, a need exists for reducing food waste.

### SUMMARY

In some embodiments, a system for reducing food waste of a user is provided that includes a store computer configured to forward food expiration information for a food item to a user device. The system also includes an application executable on a user device, the application having computer program code that, when executed by the user device, causes the user device to (a) receive food expiration information from the store computer regarding a food item purchased by the user; and (b) generate an alert on the user device, the alert indicating to the user that the food item will expire within a predetermined time period.

In some embodiments, a method is provided for reducing food waste of a user. The method includes creating an application having computer program code for use on a user device, the application, when executed by the user device, configured to employ the user device to: (a) receive food expiration information from a store computer regarding a food item purchased by the user; and (b) generate an alert, the alert indicating to the user that the food item will expire within a predetermined time period. The method also includes providing the application to a digital distribution platform for downloading. Numerous other aspects are provided in accordance with these and other embodiments provided herein.

Other objects, features and aspects of the present invention will become more fully apparent from the following detailed description, the appended claims, and the accompanying drawings.

### BRIEF DESCRIPTION OF THE DRAWINGS

FIG. 1A illustrates a top view of an example food waste reduction system in accordance with one or more embodiments provided herein.

FIG. 1B illustrates an example mobile device for use with the food reduction system of FIG. 1A in accordance with embodiments provided herein.

FIG. 2 illustrates an example method for reducing food waste in accordance with embodiments provided herein.

FIG. 3 illustrates another example food waste reduction system in accordance with one or more embodiments provided herein.

FIG. 4 illustrates another example method for reducing food waste in accordance with embodiments provided herein.

### DETAILED DESCRIPTION

As described above, each year, billions of dollars is spent producing food that is wasted. Part of this waste results from people throwing food out because it spoils or because they believe it has spoiled based on a label on the food package.

In accordance with embodiments provided herein, to reduce food waste, methods and apparatus are provided for tracking when food will expire (e.g., is unsafe to eat, is undesirable to eat, etc.), and warning a user when the food will expire. For example, in some embodiments, an application (e.g., computer program code) is provided for execution on a mobile device, such as a smartphone, a tablet computer, a smart watch, or the like, that tracks when food will expire and warns a user when the food will expire (e.g., a few days ahead, the day before, the last day the food is safe to eat, etc.). In one or more embodiments, the application may employ the mobile device to scan a bar code on each food item purchased (e.g., using a camera of the mobile device) and obtain information on the shelf life of the food item (e.g., from a local database stored on the mobile device, by accessing cloud storage and/or a remote third party server, etc.). Alternatively, a grocery store may send food expiration information to the application and/or mobile device at checkout, or at some time after checkout, as the grocery store has already scanned all the items purchased.

In some embodiments, an application may include computer program code (e.g., instructions) that, when executed by a mobile device, provide a user with reminders (e.g., alerts, entries on the user's calendar, email reminders, text reminders, etc.) about when food will and/or is about to expire. The application may include computer program code which, when executed by a mobile device, monitors multiple items for expiration and provides a user with recipes that use the items that are about to expire. For example, the application and/or mobile device might determine that shredded cheese, eggs and spinach in the user's refrigerator are expiring tomorrow and remind the user to consider having a spinach and cheese omelet for dinner, even providing a recipe.

In some embodiments, grocery stores and/or food manufacturers may facilitate reduction of food waste by sharing food expiration date information with users (e.g., at checkout, after purchase, etc.). For example, an application, when executed by a mobile device, may receive food information from a grocery or food supplier (e.g., restaurants, catering services, food delivery services, etc.) that facilitates food expiration tracking, such as best by date information, sell by date information, use by date information, lot number, food type, etc. The application may then use this information to estimate an expiration date for one or more purchased food items. This may be done locally and/or through communication with a remote server (e.g., at a food manufacturer, an online store, a restaurant, etc.).

Neighbors, family members, or other groups may share information about what foods they have that will expire soon so that anyone in the group may use the foods before they expire. For example, Jenna may be notified by an alert on her mobile phone that her neighbor Shilo has carrots that are expiring. In some embodiments, an application may include computer program code that allows Jenna to request the expiring carrots from Shilo (e.g., for free, in exchange for something identified as expiring soon that Jenna has, etc.). Users may have a network of friends with which they can automatically or selectively share data regarding food they have that is about to expire (e.g., that day, within a few days, within a week, within a user-specified time period, etc.). This may allow sharing members to collectively reduce food waste: sometimes something will expire because a person does not want it, does not have time to prepare it, or is away. A donate button may be provided that allow users to indicate that an item is available for a larger audience and/or community food rescue organizations may respond. The above functionality may be implemented, for example, as computer program code executing on one or more suitable devices (e.g., a smartphone, tablet, smart watch, laptop, desktop, remote server, or the like). Contests may be provided between groups to determine which group wastes the least amount of food, for example (e.g., by displaying piles of food which represent food waste). Rewards may be provided, such as coupons for new food items, placement on leader boards, or the like.

Product information stored on a user's mobile or other device may also be used to determine if the user has purchased food that has been recalled. For example, an application may, when executed on a mobile or other device of a user, receive recall updates and compare the recalled product information (e.g., lot number, product name, manufacturer, etc.) to products purchased by the user as indicated by product information stored by the user device. In some embodiments, recall notices on a remote server may be monitored, or push notifications of recalls may be received from a remote server, by an application executing on a mobile or other user device (e.g., a mobile telephone, a smart watch, a tablet computer, a laptop computer, a desktop computer, etc.).

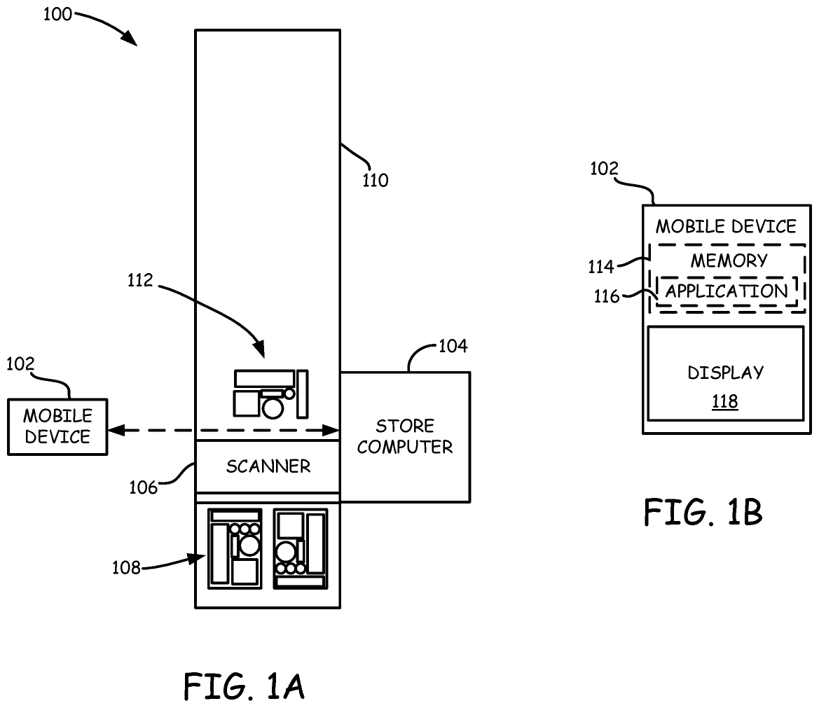

FIG. 1A illustrates a top view of an example food waste reduction system 100 in accordance with one or more embodiments provided herein. FIG. 1B illustrates an example mobile device for use within the food reduction system 100 of FIG. 1A in accordance with embodiments provided herein. With reference to FIG. 1A, system 100 includes a mobile device 102 of a user in communication with a store computer 104. For example, the mobile device 102 may be a smartphone, a smart watch, a tablet, or the like. The store computer 104 may be, for example, a cash register coupled to a scanner 106 for scanning items 108 being purchased by the user (e.g., to a compute a total owed by the user for purchasing the items). In some embodiments, the store computer 104 may be coupled to a local or remote server or other processing system for matching each scanned item with its purchase price, for inventory tracking, etc. A checkout counter 110, for example, may deliver items to be purchased (e.g., such as items 112) to scanner 106 for scanning by a store employee, for example.

In some embodiments, an application may be provided on mobile device 102 that includes computer program code (e.g., instructions) which, when executed by mobile device 102, provides a user with reminders (e.g., alerts, entries on the user's calendar, email reminders, text reminders, etc.) about when food (or another item) will and/or is about to expire. The application may include computer program code which, when executed by mobile device 102, monitors multiple items for expiration and provides a user with reminders, recipes that use the items that are about to expire, or other relevant product-use information.

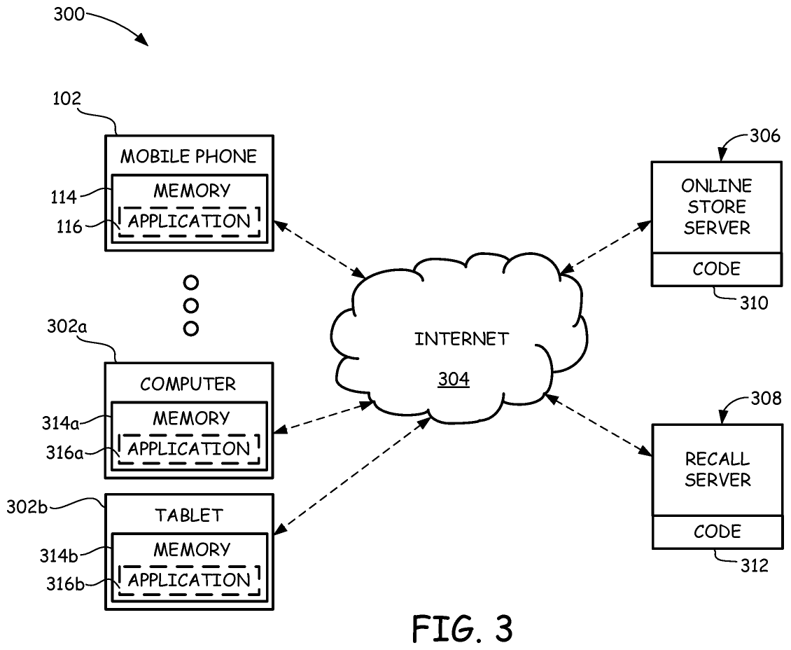

In some embodiments, grocery stores and/or food manufacturers may facilitate reduction of food waste by sharing food expiration date information with users (e.g., at checkout). For example, an application 114 stored in a memory 116 (FIG. 1B), when executed by the mobile device 102, may receive food information from a grocery or food supplier via wireless communication with store computer 104 or from a local or remote server (not shown) of the grocery store or food supplier. Application 114 may then use this information to estimate an expiration date for one or more purchased items. In some embodiments, application 114 may alert the user via a sound from and/or visual message on a display 118 of the mobile device 102 when the one or more purchased items are about to expire (e.g., within 1, 2, 3, etc., days of expiration). In some embodiments, application 114 may communicate with a server of the store (or another source of recall information) to determine if any purchased item has been recalled, and to notify the user via mobile device 102 if a purchased item has been recalled (as described below with reference to FIG. 3, for example).

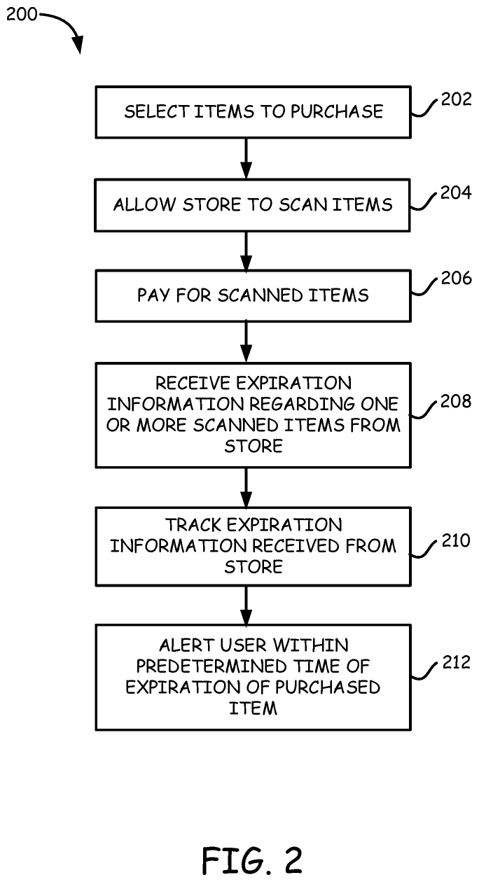

FIG. 2 illustrates an example method 200 for reducing food waste in accordance with embodiments provided herein. With reference to FIG. 2, in block 202, a user selects items for purchase. In block 204, the user allows the store to scan the items (e.g., by placing them on a checkout counter). In block 206, the user pays for the items. In block 208, the user receives expiration information from the store regarding one or more purchased items. For example, mobile device 102 may employ application 114 to communicate with store register 104, a local server, a remote server, etc., to receive expiration date information for one or more items scanned by scanner 106.

In block 210, expiration information received from the store is tracked. For example, mobile device 102 may include application 114 that directs mobile device 102 to track when purchased items expire based on the expiration information received from store computer 104 (e.g., by placing such information in a calendar or database). In some embodiments, a remote server (e.g., a grocery store, online store, food distributor, or another third-party server) may track the expiration dates. In block 212, the user is alerted when a purchased item is within a predetermined time of expiring. For example, mobile device 102 (e.g., via application 114) may notify the user that a purchased item will expire within 1, 2, 3, etc., days or within some other predetermined time period such as a user-specified time period.

FIG. 3 illustrates another example food waste reduction system 300 in accordance with one or more embodiments provided herein. With reference to FIG. 3, one or more user devices, such as mobile device 102 (e.g., a mobile telephone in this example, although other mobile devices may be used such as tablets, laptop computers, smart watches, etc.), laptop or desktop computer 302a, tablet 302b, or another similar device, are configured to communicate with a remote computer and/or server over internet 304 or another suitable communications network. For example, a user device may access internet 304 using WiFi, another wireless protocol, a wired connection, etc. Within each user device, a memory may store a food waste reduction application in accordance with one or more embodiments described herein. For example, memory 114 of mobile device 102 may include application 116, computer 302a may include a memory 314a having an application 316a stored therein, tablet 302b may include a memory 314b having an application 316b stored therein, etc. In some embodiments, application 116, 316a, and 316b may be similar but optimized for the particular user device used and include computer program code for performing one or more of the food waste reduction and/or other methods described herein.

In some embodiments, application 116, 316a and/or 316b include computer program code for communicating with or receiving communications from an online store server 306 and/or a recall server 308. Online store server 306 may include a server of an online retail store which sells food items (e.g., grocery items, prepared meals, etc.), for example. In some embodiments, online store server 306 may include computer program code 310 that allows mobile device 102, computer 302a, tablet 302b, or another user device to browse and purchase food items. Recall server 308, for example, may store information regarding food products that have been recalled. Recall server 308 may include computer program code 312 for communicating recall information to one or more of online store server 306, mobile device 102, computer 302a, tablet 302b, another user device or server, etc. For example, recall server 308 may be accessed by online store server 306 or a user device to retrieve recall information (e.g., food item, manufacturer, lot number, details of recalls such as undeclared allergens, the presence of pathogens such as norovirus, Salmonella, E. coli, etc.). Alternatively, recall server 308 may push recall information to one or more user devices and/or online store server 306. In some embodiments, recall server 308 may be part of online store server 306, hosted by the owner of online store server 306, hosted by an independent third party, or the like.

In operation, application 116, 316a, or 316b may receive food product expiration date information from online store server 306 for items purchased over (e.g., using) internet 304. For example, if mobile device 102 is employed to purchase a food item from the online store hosting online store server 306, online store server 306 via computer program code 310 may communicate food expiration information (e.g., best by date, sell by date, use by date, etc.) to mobile device 102 via application 116. Application 116 may then use the received food expiration information to track the expiration date of the purchased food item, to provide alerts to a user of mobile device 102 regarding a pending expiration of the food item, to provide a recipe that uses the food item, etc. Applications 316a and 316b may operate similarly. While tracking expiration dates, application 116, 316a, or 316b may check recall server 308 to determine if any purchased items have been recalled (and to notify a user of the same). For example, application 116, 316a, or 3016b may include computer program code for accessing recall server 308 over internet 304 and retrieving recall information and/or for receiving recall information pushed by recall server 308 or online store server 306. Likewise, online store server 306 may monitor recall dates and provide recall information to application 116, 316a or 316b. As stated, recall server 308 may push recall information to online store server 306 and/or applications 116, 316a or 316b in some embodiments.

In some embodiments, a system for reducing food waste of a user may include a store computer (e.g., store computer 104 or online store server 306) configured to forward food expiration information for a food item to a user device. The store computer may be located at a physical (e.g., brick and mortar) grocery store, an online store, or the like. The store computer may include an inventory management computer of a store, a server, or another similar system, for example.

The system may also include an application executable on a user device, such as application 116, 316a and/or 316b configured for storage in a mobile device, tablet computer, laptop computer, desktop computer, smart watch, etc. The application may have computer program code that, when executed by the user device, causes the user device to (a) receive food expiration information from the store computer regarding a food item purchased by the user; and (b) generate an alert on the user device, the alert indicating to the user that the food item will expire within a predetermined time period.

In some embodiments, the application, when executed by the user device, may receive food expiration information from a grocery store that has scanned one or more food items being purchased by the user. The application, when executed by the user device, may track food expiration information for a food item and notify a user of the user device prior to expiration of the food item. For example, the application, when executed by the user device, may notify a user by at least one of generating a sound on the user device and displaying a message on the user device.

In some embodiments, the application, when executed by the user device, may notify a user within a user-specified time period of a day the food item expires (e.g., a day, two days, or some other user-specified time period). The application may also track whether a food item purchased by the user has been recalled. For example, the application may receive recall information from a remote server. In some embodiments, the application may allow the user device to communicate to a user contact (e.g., a friend, a neighbor, a group member, etc.) that a food item will expire within a predetermined time period.

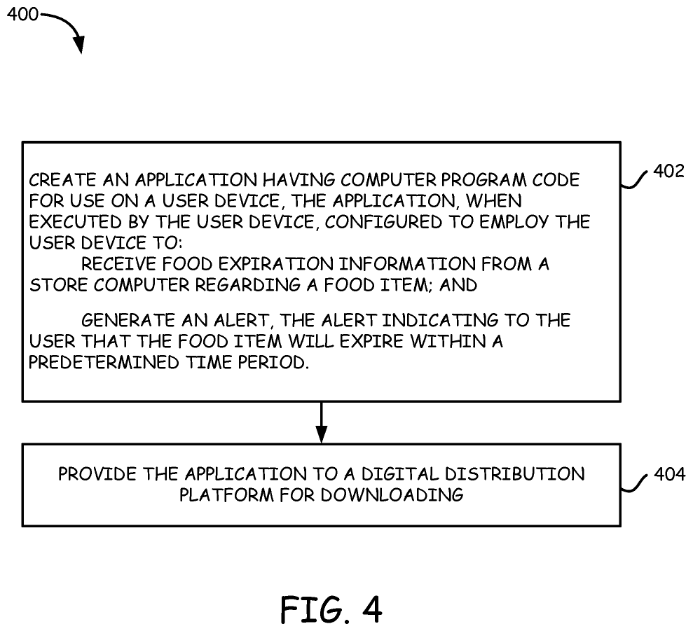

FIG. 4 illustrates example method 400 for reducing food waste in accordance with embodiments provided herein. With reference to FIG. 4, method 400 includes, in block 402, creating an application having computer program code for use on a user device such as a mobile telephone, a smart watch, a tablet, a laptop computer, or the like. For example, a developer or other party may create an application using a suitable development environment and computer language. The application, when executed by a user device, is configured to employ the user device to receive food expiration information from a store computer regarding a food item purchased by the user (e.g., at a physical store, an online store, etc.). The application is further configured to generate an alert, the alert indicating to the user that the food item will expire within a predetermined time period (e.g., a visual and/or auditory alert indicating food with expire within a day, two days, 3 days, etc.). Method 400 further includes, in block 404, providing the application to a digital distribution platform for downloading. For example, a developer or other party may submit the application to an app store. In some embodiments, the store computer may include an inventory management computer of a store or another computer and/or server. In one or more embodiments, the application may receive food expiration information from a grocery store that has scanned one or more food items being purchased by the user. The application may track food expiration information for a food item and notify a user of the user device prior to expiration of the food item. For example, the application may notify a user by at least one of generating a sound on the user device and displaying a message on the user device. In some embodiments, the application may track whether a food item purchased by the user has been recalled.

The foregoing description discloses only example embodiments of the present invention. Modifications of the above disclosed apparatus and methods which fall within the scope of the invention will be readily apparent to those skilled in the art. In some embodiments, one or more of the applications described herein may include computer program code that employs location tracking features of a user device, such as GPS, to track a location of a user. In one or more embodiments, if the user of the user device is in his or her kitchen, the application may cause the user device to notify the user to consider consuming a food item that will expire soon (e.g., within 1, 2, or 3 days or some other time period). In addition, or alternatively, the application may identify a time (or times) of the day when the user typically eats a meal or a snack and may notify the user (via the user device) at such a time (or times) to consider consuming a food item that will expire soon (e.g., identifying the food that will expire soon, providing a recipe that uses the food that will expire soon, etc.). Such times of the day for meals or snacks may be user specified or otherwise determined, for example. In one or more embodiments, if the user of the user device is in a grocery store or shopping online, the application may notify the user to consider purchasing a food item to eat with a food item that will expire soon (e.g., rice to consume with beans that will expire soon).

The methods for food waste reduction described herein may be employed on any suitable user device (e.g., a mobile telephone, a smart watch, a tablet computer, a laptop computer, a desktop computer, etc.). For example, an applications executable by a user device may be stored in a memory of the user device and executed by a processor of the user device.

Accordingly, while the present invention has been disclosed in connection with the example embodiments thereof, it should be understood that other embodiments may fall within the spirit and scope of the invention, as defined by the following claims.

The invention claimed is:

1. A system for reducing food waste of a user comprising:
a store computer configured to forward food expiration information for a food item to a user device;
an application executable on a user device, the application having computer program code that, when executed by the user device, causes the user device to:
receive food expiration information from the store computer regarding a food item purchased by the user; and
generate an alert on the user device, the alert indicating to the user that the food item will expire within a predetermined time period.

2. The system of claim 1 wherein the store computer comprises an inventory management computer of a store.

3. The system of claim 2 wherein the store computer comprises a server.

4. The system of claim 2 wherein the store is an online store.

5. The system of claim 2 wherein the store is a physical store.

6. The system of claim 1 wherein the application, when executed by the user device, receives food expiration information from a grocery store that has scanned one or more food items being purchased by the user.

7. The system of claim 1 wherein the application, when executed by the user device, tracks food expiration information for a food item and notifies a user of the user device prior to expiration of the food item.

8. The system of claim 7 wherein the application, when executed by the user device, notifies a user by at least one of generating a sound on the user device and displaying a message on the user device.

9. The system of claim 7 wherein the application, when executed by the user device, notifies a user within a user-specified time period of a day the food item expires.

10. The system of claim 1 wherein the application, when executed by the user device, tracks whether a food item purchased by the user has been recalled.

11. The system of claim 10 wherein the application, when executed by the user device, receives recall information from a remote server.

12. The system of claim 1 wherein the user device is a mobile device.

13. The system of claim 1 wherein the application, when executed by the user device, allows the user device to communicate with a user contact that a food item will expire within a predetermined time period.

14. A method for reducing food waste of a user comprising:
creating an application having computer program code for use on a user device, the application, when executed by the user device, configured to employ the user device to:
receive food expiration information from a store computer regarding a food item purchased by the user; and
generate an alert, the alert indicating to the user that the food item will expire within a predetermined time period; and
providing the application to a digital distribution platform for downloading.

15. The method of claim 14 wherein the store computer comprises an inventory management computer of a store.

16. The method of claim 15 wherein the store computer comprises a server.

17. The method of claim 14 wherein the application, when executed by the user device, is configured to receive food expiration information from a grocery store that has scanned one or more food items being purchased by the user.

18. The method of claim 14 wherein the application, when executed by the user device, is configured to track food expiration information for a food item and notify a user of the user device prior to expiration of the food item.

19. The method of claim 18 wherein the application, when executed by the user device, is configured to notify a user by at least one of generating a sound on the user device and displaying a message on the user device.

20. The method of claim 14 wherein the application, when executed by the user device, is configured to track whether a food item purchased by the user has been recalled.
